(19) United States
(12) Patent Application Publication
(10) Pub. No.: US 2019/0004578 A1
(43) Pub. Date: Jan. 3, 2019

(54) ELECTRONIC DEVICE

(71) Applicant: Panasonic Intellectual Property Management Co., Ltd., Osaka (JP)

(72) Inventor: Toru WANIBUCHI, Hyogo (JP)

(21) Appl. No.: 16/041,831

(22) Filed: Jul. 22, 2018

Related U.S. Application Data
(63) Continuation of application No. PCT/JP2017/003521, filed on Feb. 1, 2017.

(30) Foreign Application Priority Data
Feb. 22, 2016 (JP) 2016-030913

(51) Int. Cl. G06F 1/26; G06F 1/16; H02J 7/34

(52) U.S. Cl. CPC G06F 1/263; H01M 10/44; H02J 7/34; G06F 1/1635

(57) ABSTRACT

The electronic device includes a main battery that supplies electric power to a load circuit, a sub-battery that supplies electric power to the load circuit in a case where the main battery is detached from the electronic device, a first charging circuit that charges the main battery, a second charging circuit that charges the sub-battery, and a controller that controls the first and second charging circuits. The controller changes a setting value of a charging electric current for the sub-battery in the second charging circuit based on an amount of charge of the main battery.

### BACKGROUND

### 1. Technical Field

The present disclosure relates to an electronic device having a replaceable battery. More specifically, the present disclosure relates to an electronic device having a battery that can be replaced while power of the electronic device is on.

### 2. Description of Related Art

Unexamined Japanese Patent Publication No. 07-241046 discloses a charging electric current switching method for performing optimum trickle charging by switching trickle charging of a sub-battery in accordance with a state such as whether or not there is an alternating current (AC) adapter, whether or not a system is in a standby state, or whether or not a main battery still has a charge, for keeping a resume state as long as possible, and for preventing excessive discharge of the main battery.

According to the charging electric current switching method disclosed in Unexamined Japanese Patent Publication No. 07-241046, excessive discharge of the main battery is prevented by stopping trickle charging of the sub-battery when the remaining battery level of the main battery becomes equal to or lower than a predetermined value during supply of a direct current voltage from the main battery to a load.

### SUMMARY

The present disclosure provides an electronic device that can speedily create an environment allowing for replacement of a battery without interruption of a user's operation.

An aspect of the present disclosure provides an electronic device including a load circuit. The electronic device includes a main battery that supplies electric power to a load circuit, a sub-battery that supplies electric power to the load circuit in a case where the main battery is detached from the electronic device, a first charging circuit that charges the main battery, a second charging circuit that charges the sub-battery, and a controller that controls the first and second charging circuits. The controller changes a setting value of a charging electric current for the sub-battery in the second charging circuit based on an amount of charge of the main battery.

According to the present disclosure, the sub-battery is rapidly charged when an amount of charge of the main battery decreases. Therefore, the sub-battery can be quickly set to a fully charged state during a period in which it is highly likely that the main battery is replaced. Therefore, for example, the sub-battery that supplies electric power during replacement of the battery can be kept in a sufficiently charged state. This makes it possible to speedily create an environment for replacing a main battery as soon as a user recognizes that an amount of charge (remaining battery level) of the main battery is small.

### BRIEF DESCRIPTION OF THE DRAWINGS

FIG. 1 is a configuration diagram of an information processing device according to a first exemplary embodiment of the present disclosure;

FIG. 2 is a flowchart showing an operation for setting a charging electric current in the information processing device according to the first exemplary embodiment;

FIG. 3A is a view for illustrating the operation for setting a charging electric current in the information processing device according to the first exemplary embodiment;

FIG. 3B is a view for illustrating the operation for setting a charging electric current in the information processing device according to the first exemplary embodiment;

FIG. 3C is a view for illustrating the operation for setting a charging electric current in the information processing device according to the first exemplary embodiment;

FIG. 4A is a view for illustrating the operation for setting a charging electric current in the information processing device according to the first exemplary embodiment;

FIG. 4B is a view for illustrating the operation for setting a charging electric current in the information processing device according to the first exemplary embodiment;

FIG. 4C is a view for illustrating the operation for setting a charging electric current in the information processing device according to the first exemplary embodiment;

FIG. 5 is a flowchart showing an operation for setting a charging electric current in information processing device according to a second exemplary embodiment;

FIG. 6A is a view for illustrating the operation for setting a charging electric current in the information processing device according to the second exemplary embodiment;

FIG. 6B is a view for illustrating the operation for setting a charging electric current in the information processing device according to the second exemplary embodiment; and

FIG. 6C is a view for illustrating the operation for setting a charging electric current in the information processing device according to the second exemplary embodiment.

### DETAILED DESCRIPTION

Hereinafter, exemplary embodiments will be described in detail with reference to drawings as appropriate. However, detailed description more than necessary may be omitted. For example, in some cases, a detailed description of a matter which is already well known, and a repeated description of substantially the same configuration will be omitted. These omissions are made to avoid unnecessary redundancy of the following description, and to facilitate the understanding of those skilled in the art.

Note that the inventors of the present disclosure provide the accompanying drawings and the following description in order to allow those skilled in the art to fully understand the present disclosure, and do not intend to limit the subject matter as described in the appended claims.

### First Exemplary Embodiment

1-1. Configuration

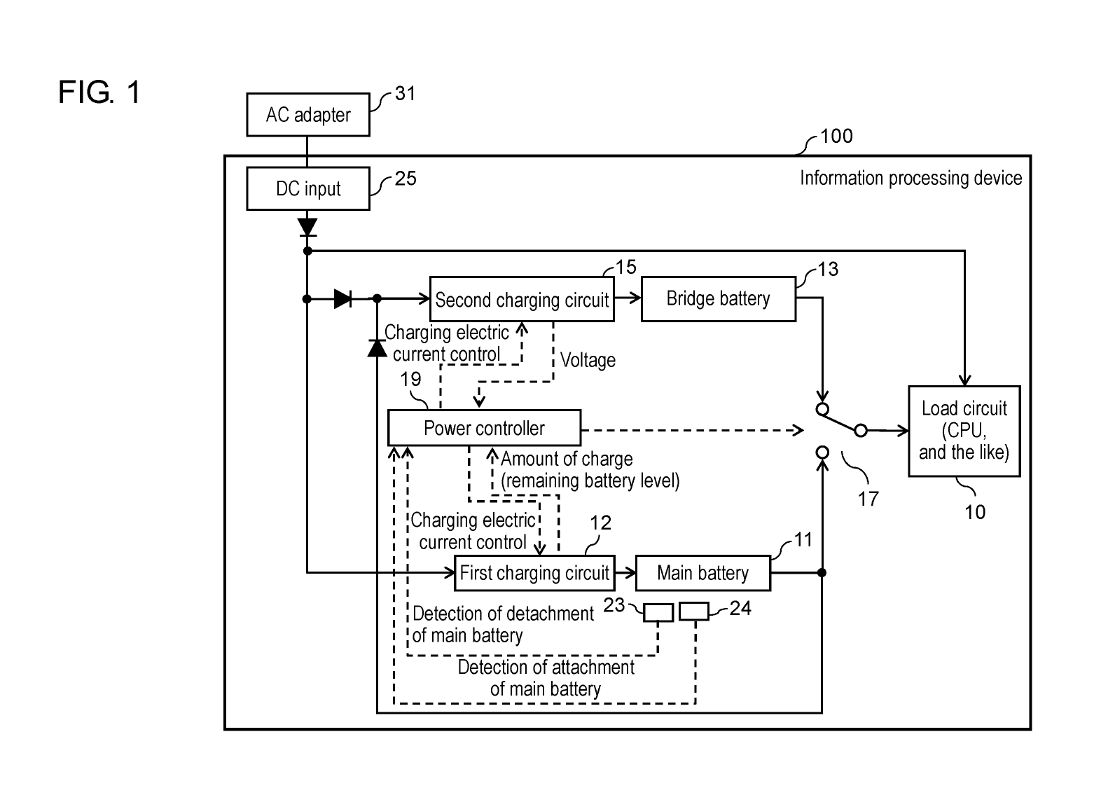

FIG. 1 is a block diagram showing a configuration of an information processing device that is an example of an electronic device according to a first exemplary embodiment of the present disclosure. In particular, FIG. 1 shows a configuration concerning a battery charging process in the information processing device. Information processing device 100 is an electronic device having a replaceable battery and is, for example, a notebook computer or a tablet computer.

Information processing device 100 includes load circuit 10, main battery 11 that supplies electric power to load circuit 10, and bridge battery 13 that supplies electric power to load circuit 10 in a case where no electric power is supplied from main battery 11. Information processing device 100 further includes first charging circuit 12 that controls charging of main battery 11, second charging circuit 15 that controls charging of bridge battery 13, and power controller 19 that controls charging of main battery 11 and bridge battery 13. Information processing device 100 further includes change-over switch 17 that switches a battery that supplies electric power to load circuit 10, first detector 23 that detects detachment of main battery 11 from information processing device 100, second detector 24 that detects attachment of main battery 11 to information processing device 100, and DC input 25.

Load circuit 10 includes a central processing unit (CPU), a volatile memory such as random access memory (RAM), nonvolatile memories such as a read only memory (ROM) and a solid state drive (SSD), and a liquid crystal display device and further includes various circuits for allowing information processing device 100 to accomplish functions as a computer. In the non-volatile memories (such as the ROM and the SSD), an operating system (OS), various application programs, various data, and the like are stored. The central processing unit (CPU) reads the OS, the application programs, and the various data and performs arithmetic processing to perform various functions.

Main battery 11 is a rechargeable battery and is, for example, a lithium-ion battery. Main battery 11 is detachable from a main body of information processing device 100. That is, information processing device 100 is configured so that main battery 11 is replaceable.

Bridge battery 13 is a spare battery (an example of a sub-battery) that supplies electric power to load circuit 10 in a case where no electric power is supplied from main battery 11 (e.g., during replacement of main battery 11). Bridge battery 13 is a rechargeable battery and is, for example, a lithium-ion battery. Bridge battery 13 is provided in order to supply electric power to load circuit 10 during replacement of main battery 11. Bridge battery 13 is a battery that is built into information processing device 100 and cannot be replaced by a user. Bridge battery 13 is a spare battery, and therefore a capacity of bridge battery 13 is set smaller than a capacity of main battery 11.

First charging circuit 12 is a circuit that controls charging of main battery 11. Second charging circuit 15 is a circuit that controls charging of bridge battery 13.

Power controller 19 is a circuit that controls charging of main battery 11 and bridge battery 13. Power controller 19 is a programmable microcontroller. Power controller 19 receives a detection signal from each of first and second detectors 23 and 24. Power controller 19 controls first and second charging circuits 12 and 15 and controls change-over switch 17.

Furthermore, power controller 19 manages amounts of charge (remaining battery levels) of main battery 11 and bridge battery 13.

First detector 23 is a device that detects a state where main battery 11 is about to be detached from the main body of information processing device 100. For example, in a case where main battery 11 has a lever for detachment and a user operates the lever in order to detach main battery 11 from the main body of information processing device 100, first detector 23 is configured to detect the operation of the lever (detaching operation). That is, first detector 23 detects not a state where main battery 11 has been detached, but a state immediately before detachment of main battery 11. First detector 23 is, for example, a mechanical switch that is in synchronization with movement of the lever for detachment. Alternatively, first detector 23 may be configured to electrically detect movement of the lever by using, for example, a Hall element.

Second detector 24 is a device that outputs a detection signal indicating whether or not main battery 11 is attached to information processing device 100. For example, second detector 24 can be a circuit that outputs “High” in a case where main battery 11 is detached from information processing device 100 and outputs “Low” in a case where main battery 11 is attached to information processing device 100.

AC adapter 31 that converts commercial power into a predetermined direct-current voltage can be connected to information processing device 100 according to the present exemplary embodiment. DC input 25 receives a direct-current voltage from AC adapter 31 in a case where AC adapter 31 is connected to information processing device 100. DC input 25 is, for example, an input terminal.

1-2. Operation

An operation of information processing device 100 configured as above, especially an operation concerning power supply to load circuit 10 is described below.

In a case where AC adapter 31 is not connected to information processing device 100, power controller 19 controls change-over switch 17 so that electric power is supplied from main battery 11 to load circuit 10. In this case, bridge battery 13 is charged with electric power supplied from main battery 11.

Meanwhile, in a case where AC adapter 31 is connected to information processing device 100, a direct-current voltage supplied from AC adapter 31 is supplied to load circuit 10 via DC input 25. Concurrently, main battery 11 is charged with the direct-current voltage supplied from AC adapter 31 by first charging circuit 12. Furthermore, bridge battery 13 is charged with the direct-current voltage supplied from AC adapter 31 by second charging circuit 15.

As described above, bridge battery 13 is charged based on electric power supplied from AC adapter 31 in a case where AC adapter 31 is connected, and bridge battery 13 is charged based on electric power supplied from main battery 11 in a case where AC adapter 31 is not connected.

Power controller 19 receives a detection signal from first detector 23 at predetermined intervals and detects whether or not an operation for detaching main battery 11 has been performed based on the received detection signal. In a case where power controller 19 detects the operation for detaching main battery 11, power controller 19 switches a battery that supplies electric power to load circuit 10 from main battery 11 to bridge battery 13 by controlling change-over switch 17. This makes it possible to supply electric power from bridge battery 13 to load circuit 10 even while main battery 11 is being detached. Consequently, information processing device 100 can continuously operate even while main battery 11 is being temporarily detached for replacement of main battery 11. In this way, in information processing device 100 according to the present exemplary embodiment, main battery 11 can be replaced while power is on. Hereinafter, the function of replacing main battery 11 while power is on is referred to as “hot swapping”. In particular, the battery is switched to bridge battery 13 upon detection of the operation for detaching main battery 11. This makes it possible to start power supply from bridge battery 13 to load circuit 10 before main battery 11 is actually detached from information processing device 100, and thus avoiding interruption of power supply to information processing device 100.

As described above, information processing device 100 according to the present exemplary embodiment has a hot swapping function of replacing main battery 11 while power of the main body is on. For this purpose, information processing device 100 includes bridge battery 13 that supplies power to the main body only for a short period during which main battery 11 is detached from information processing device 100. As described above, bridge battery 13 is charged based on electric power supplied from AC adapter 31 in a case where AC adapter 31 is connected, and bridge battery 13 is charged based on electric power supplied from main battery 11 in a case where AC adapter 31 is not connected.

Bridge battery 13 is incorporated into the main body of information processing device 100 and cannot be replaced by a user. For this reason, there are demands for making lifetime of bridge battery 13 as long as possible, and for this purpose, stress during charging is decreased by suppressing a charging electric current.

In a state where the remaining battery level of main battery 11 is low, it is highly likely that a user replaces main battery 11 in near future. However, in a case where an amount of charge of bridge battery 13 is small, the user undesirably cannot detach main battery 11 while information processing device 100 is on (i.e., hot swapping cannot be performed).

In order to solve this problem, information processing device 100 according to the present exemplary embodiment temporarily increases a charging electric current supplied to bridge battery 13 in a case where an amount of charge (remaining battery level) of main battery 11 to be replaced is small. This makes it possible to rapidly charge bridge battery 13 until an amount of charge with which hot swapping can be performed. It is therefore possible to speedily create an environment for replacement of main battery 11 without interruption of a user's operation even in a case where the remaining battery level of main battery 11 is low. Setting of a charging electric current in second charging circuit 15 that charges bridge battery 13 is described below.

1-2-1. Setting of Charging Electric Current for Bridge Battery

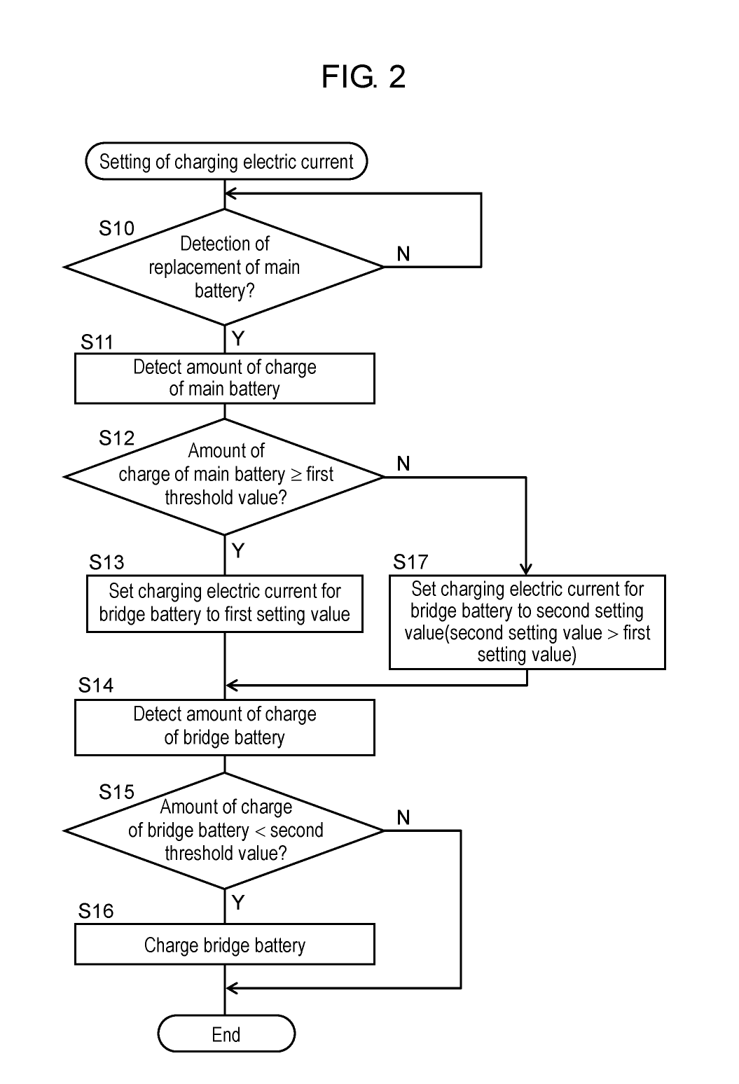

Power controller 19 sets a charging electric current value for charging of bridge battery 13 in second charging circuit 15. FIG. 2 is a flowchart showing how power controller 19 sets a charging electric current in second charging circuit 15 upon detection of replacement of main battery 11. An operation for setting a charging electric current in second charging circuit 15 is described below with reference to the flowchart of FIG. 2.

Power controller 19 determines whether or not main battery 11 has been replaced (S10). Whether or not main battery 11 has been replaced can be determined based on a detection signal received from second detector 24. For example, replacement of main battery 11 can be detected in a case where attachment of main battery 11 is detected based on the detection signal received from second detector 24 (in a case where a change of the detection signal from “High” to “Low” is detected). In a case where replacement of main battery 11 is detected, power controller 19 detects an amount of charge (remaining battery level) of main battery 11 (S11).

Power controller 19 compares the detected amount of charge of main battery 11 with a first threshold value (S12). The first threshold value is set, for example, to a value that is equal to or smaller than 20% of a full charge amount of main battery 11. In a case where the detected amount of charge of main battery 11 is equal to or larger than the first threshold value (YES in S12), power controller 19 sets a setting value of a charging electric current for bridge battery 13 in second charging circuit 15 to a first setting value (a usual charging electric current value) (S13).

Meanwhile, in a case where the detected amount of charge of main battery 11 is smaller than the first threshold value (NO in S12), power controller 19 sets the setting value of the charging electric current for bridge battery 13 in second charging circuit 15 to a second setting value that is larger than the first setting value (S17).

Then, power controller 19 detects an amount of charge of bridge battery 13 (S14). An amount of charge of bridge battery 13 is detected, for example, based on a voltage of bridge battery 13.

Power controller 19 compares the detected amount of charge of bridge battery 13 with a second threshold value (S15). The second threshold value is, for example, set to a value of an amount of charge so that electric power that allows load circuit 10 to perform a continuous operation can be supplied from bridge battery 13 to load circuit 10 even in a case where it takes one minute to replace main battery 11.

In a case where the amount of charge of bridge battery 13 is smaller than the second threshold value (YES in S15), power controller 19 charges bridge battery 13 by controlling second charging circuit 15 (S16). In this step, second charging circuit 15 charges bridge battery 13 based on the setting value of the charging electric current that has been set. In a case where the setting value of the charging electric current for bridge battery 13 is set to the second setting value, bridge battery 13 is rapidly charged.

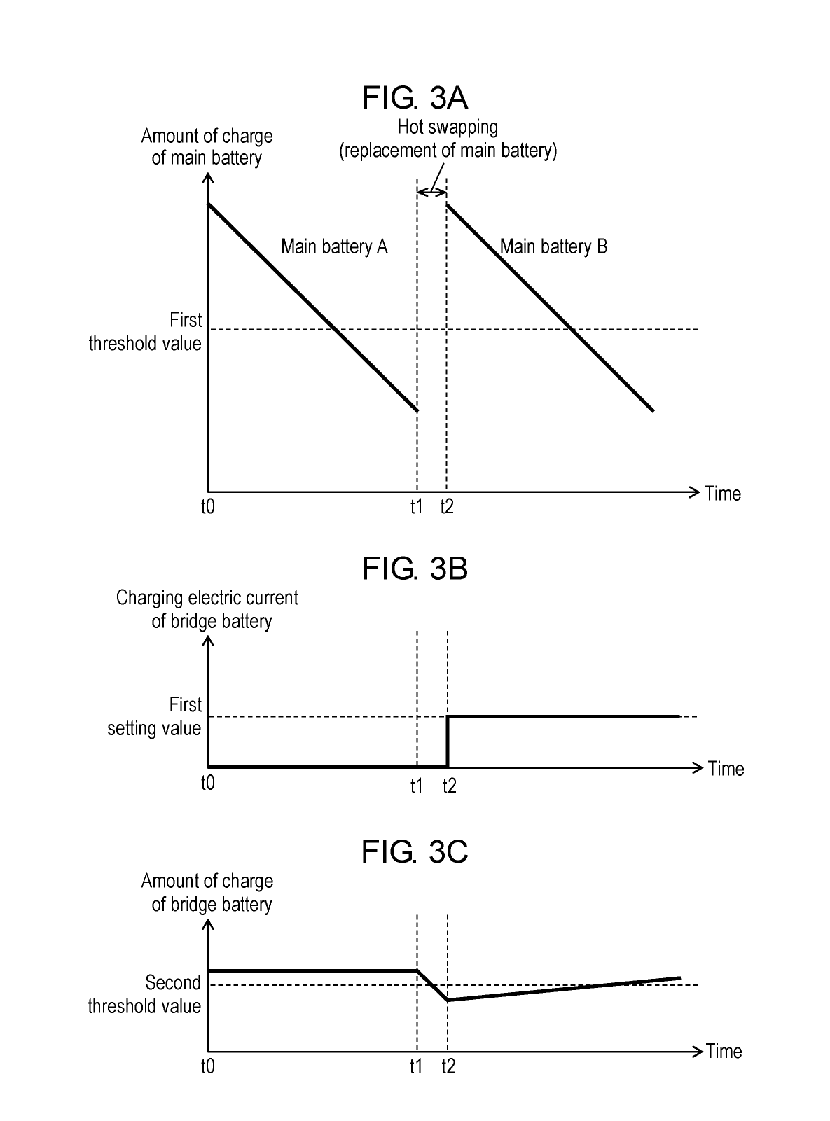

FIG. 3 is a view for illustrating an example of an operation for setting a setting value of a charging electric current for bridge battery 13 during hot swapping of main battery 11.

FIG. 3 illustrates a state where main battery A is initially connected to information processing device 100 and then main battery A is replaced with another main battery B. FIG. 3A illustrates a charging state of a main battery. FIG. 3B illustrates a setting value of a charging electric current for bridge battery 13. FIG. 3C illustrates a change of a charging state of bridge battery 13.

As illustrated in FIG. 3A, main battery A is detached from information processing device 100 at time t1, and main battery B is attached to information processing device 100 at time t2. As illustrated in FIG. 3C, bridge battery 13 is in an almost fully charged state until time t1 until which main battery A is attached to information processing device 100. Since it is unnecessary to charge bridge battery 13, the setting value of the charging electric current for bridge battery 13 is set to 0 as illustrated in FIG. 3B. Electric power is supplied from bridge battery 13 to load circuit 10 between time t1 at which main battery A is detached from information processing device 100 to time t2 at which main battery B is attached to information processing device 100. Accordingly, an amount of charge of bridge battery 13 decreases due to discharge of bridge battery 13 during time t1 and time t2, as illustrated in FIG. 3C.

In a case where replacement of the main battery is detected at time t2 in this state, power controller 19 determines an amount of charge (voltage) of newly connected main battery B. In the example of FIG. 3A, the amount of charge (voltage) of newly connected main battery B is higher than the first threshold value immediately after replacement, and therefore the setting value of the charging electric current for bridge battery 13 is set to the first setting value that is a usual setting value of the charging electric current, as illustrated in FIG. 3B. As illustrated in FIG. 3C, since the amount of charge of bridge battery 13 is smaller than the second threshold value immediately after replacement of main battery 11, bridge battery 13 is charged based on the first setting value. As a result, the amount of charge of bridge battery 13 increases after time t2.

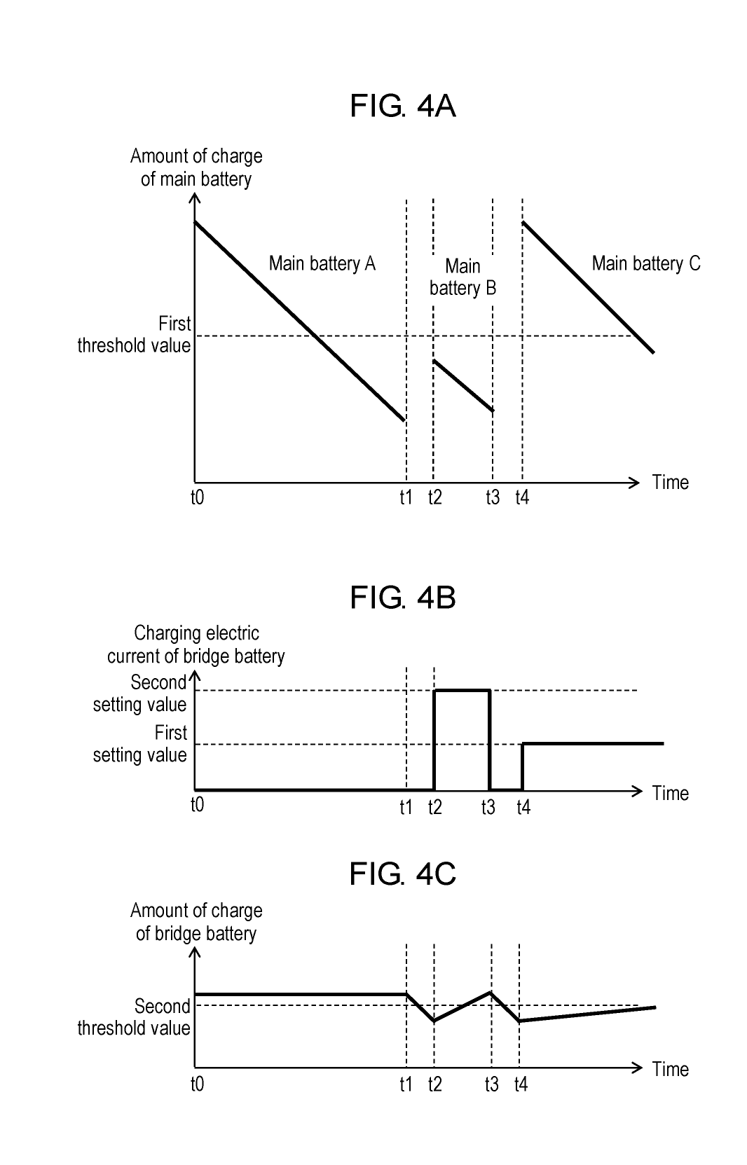

FIG. 4 is a view for illustrating a change of a setting value of a charging electric current for bridge battery 13 during hot swapping in a case where an amount of charge of replacement main battery 11 is small. FIG. 4 illustrates a case where main battery A is connected to information processing device 100, then main battery A is replaced with main battery B, and then main battery B is replaced with main battery C.

FIG. 4A illustrates a charging state of a main battery. FIG. 4B illustrates a setting value of a charging electric current for bridge battery 13. FIG. 4C illustrates a change of a charging state of bridge battery 13.

As illustrated in FIG. 4A, main battery A is detached from information processing device 100 at time t1, and main battery B is attached to information processing device 100 at time t2. Then, main battery B is detached from information processing device 100 at time t3, and main battery C is attached to information processing device 100 at time t4.

In this case, an amount of charge of bridge battery 13 is larger than the second threshold value until time t1 until which main battery A is attached to information processing device 100, as illustrated in FIG. 4C. Since it is unnecessary to charge bridge battery 13, the setting value of the charging electric current for bridge battery 13 is set to 0 as illustrated in FIG. 4B. Electric power is supplied from bridge battery 13 to load circuit 10 between time t1 at which main battery A is detached from information processing device 100 to time t2 at which main battery B is attached to information processing device 100. Accordingly, the amount of charge of bridge battery 13 decreases due to discharge of bridge battery 13 and becomes lower than the second threshold value during time t1 and time t2, as illustrated in FIG. 4C. When main battery B is attached to information processing device 100 at time t2, bridge battery 13 is charged by second charging circuit 15, and therefore the amount of charge of bridge battery 13 increases.

Then, main battery B is detached from information processing device 100 at time t3, and main battery C is attached to information processing device 100 at time t4. The amount of charge of bridge battery 13 decreases due to discharge of bridge battery 13 and becomes lower than the second threshold value between time t3 and time t4. Then, when main battery C is attached to information processing device 100 at time t4, bridge battery 13 is charged, and the amount of charge of bridge battery 13 increases accordingly.

As illustrated in FIG. 4A, the amount of charge (voltage) of main battery B is lower than the first threshold value at time t2 at which the main battery is replaced. Accordingly, power controller 19 sets the setting value of the charging electric current for bridge battery 13 to the second setting value that is higher than the first setting value, as illustrated in FIG. 4B. This rapidly charges bridge battery 13, and thus allowing bridge battery 13 to reach a fully charged state earlier than usual charging (charging based on the first setting value).

Meanwhile, the amount of charge (voltage) of main battery C is higher than the first threshold value at time t4 at which the main battery is replaced. Accordingly, power controller 19 sets the setting value of the charging electric current for bridge battery 13 to the first setting value, as illustrated in FIG. 4B. As a result, bridge battery 13 is charged as usual.

As described above, in information processing device 100 according to the present exemplary embodiment, the setting value of the charging electric current for bridge battery 13 is changed in accordance with an amount of charge of main battery 11 at the time of replacement of main battery 11. Specifically, in a case where the amount of charge of main battery 11 is smaller than the first threshold value, the setting value of the charging electric current for bridge battery 13 is set larger. This makes it possible to rapidly charge bridge battery 13, and thus allowing bridge battery 13 to reach a fully charged state in a case where the amount of charge of main battery 11 is small.

1-3. Effects and Other Benefits

As described above, information processing device 100 (an example of an electronic device) according to the present exemplary embodiment includes load circuit 10. Information processing device 100 includes main battery 11 (an example of a main battery) that supplies electric power to load circuit 10, bridge battery 13 (an example of a sub-battery) that supplies electric power to load circuit 10 in a case where main battery 11 is detached from information processing device 100, first charging circuit 12 that charges main battery 11, second charging circuit 15 that charges bridge battery 13, and power controller 19 (an example of a controller) that controls first and second charging circuits 12 and 15. Power controller 19 changes a setting value of a charging electric current for bridge battery 13 in second charging circuit 15 based on an amount of charge of main battery 11.

More specifically, power controller 19 sets the setting value of the charging electric current for bridge battery 13 to the first setting value in a case where replacement of main battery 11 is detected (YES in S10) and where an amount of charge of main battery 11 is equal to or larger than the first threshold value (an example of a predetermined threshold value) (YES in S12). Meanwhile, in a case where the amount of charge of main battery 11 is smaller than the first threshold value (NO in S12), the setting value of the charging electric current for bridge battery 13 is set to the second setting value that is larger than the first setting value (S17).

According to the above configuration, in a case where the amount of charge of main battery 11 is small, bridge battery 13 is speedily charged and can therefore be speedily set to a fully charged state. That is, bridge battery 13 can be speedily set to a fully charged state during a period in which it is highly likely that main battery 11 is replaced. Therefore, for example, bridge battery 13 that supplies electric power during replacement of main battery 11 can be kept in a sufficiently charged state. This makes it possible to speedily create an environment for replacing a main battery as soon as a user recognizes that an amount of charge (remaining battery level) of main battery 11 is small.

### Second Exemplary Embodiment

In the first exemplary embodiment, an amount of charge of main battery 11 is checked at a time of replacement of main battery 11, and a setting value of a charging electric current for bridge battery 13 is set. Meanwhile, in the second exemplary embodiment, information processing device 100 always checks an amount of charge of main battery 11 while power is on and increases a setting value of a charging electric current for bridge battery 13 in a case where the amount of charge of main battery 11 becomes low. An operation for setting a charging electric current for bridge battery 13 in the second exemplary embodiment is described below. A configuration of information processing device 100 according to the second exemplary embodiment is similar to the configuration described in the first exemplary embodiment.

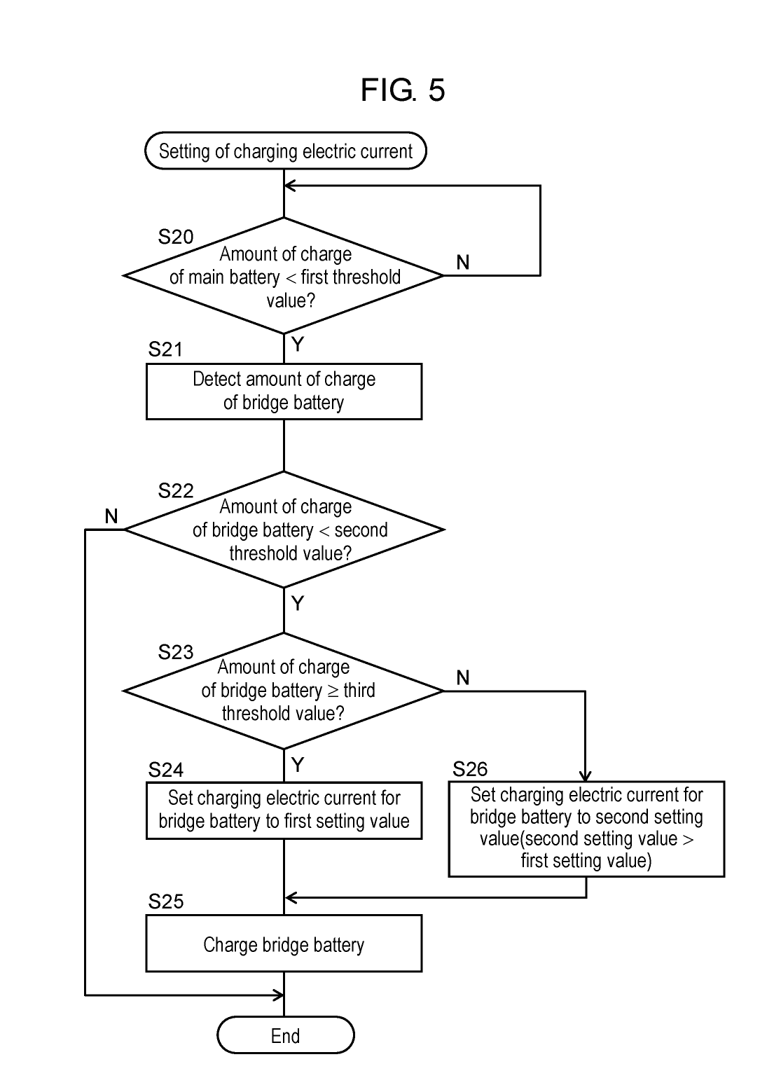

FIG. 5 is a flowchart showing an operation for setting a charging electric current in information processing device 100 according to the second exemplary embodiment. An operation for setting a charging electric current in information processing device 100 according to the present exemplary embodiment is described below with reference to the flowchart of FIG. 5.

Power controller 19 detects an amount of charge (remaining battery level) of main battery 11 and determines whether or not the amount of charge is lower than a first threshold value (S20). In a case where the amount of charge of main battery 11 is lower than the first threshold value (YES in S20), power controller 19 detects an amount of charge of bridge battery 13 (S21). An amount of charge (remaining battery level) of bridge battery 13 is detected, for example, based on a voltage of bridge battery 13.

Power controller 19 compares the detected amount of charge of bridge battery 13 with a second threshold value (S22). In a case where the detected amount of charge of bridge battery 13 is equal to or larger than the second threshold value (NO in S22), this processing is finished.

Meanwhile, in a case where the amount of charge of bridge battery 13 is smaller than the second threshold value (YES in S22), power controller 19 compares the detected amount of charge of bridge battery 13 with a third threshold value (S23). The third threshold value is set smaller than the second threshold value.

In a case where the detected amount of charge of bridge battery 13 is equal to or larger than the third threshold value (YES in S23), power controller 19 sets a setting value of a charging electric current for bridge battery 13 in second charging circuit 15 to a first setting value (a usual charging electric current value) (S24). Meanwhile, in a case where the detected amount of charge of bridge battery 13 is smaller than the third threshold value (NO in S23), power controller 19 sets the setting value of the charging electric current for bridge battery 13 to a second setting value that is larger than the first setting value (S26).

Then, power controller 19 charges bridge battery 13 by controlling second charging circuit 15 (S25). In this step, second charging circuit 15 charges bridge battery 13 based on the setting value of the charging electric current that has been set. In a case where the setting value of the charging electric current for bridge battery 13 is set to the second setting value, bridge battery 13 is rapidly charged.

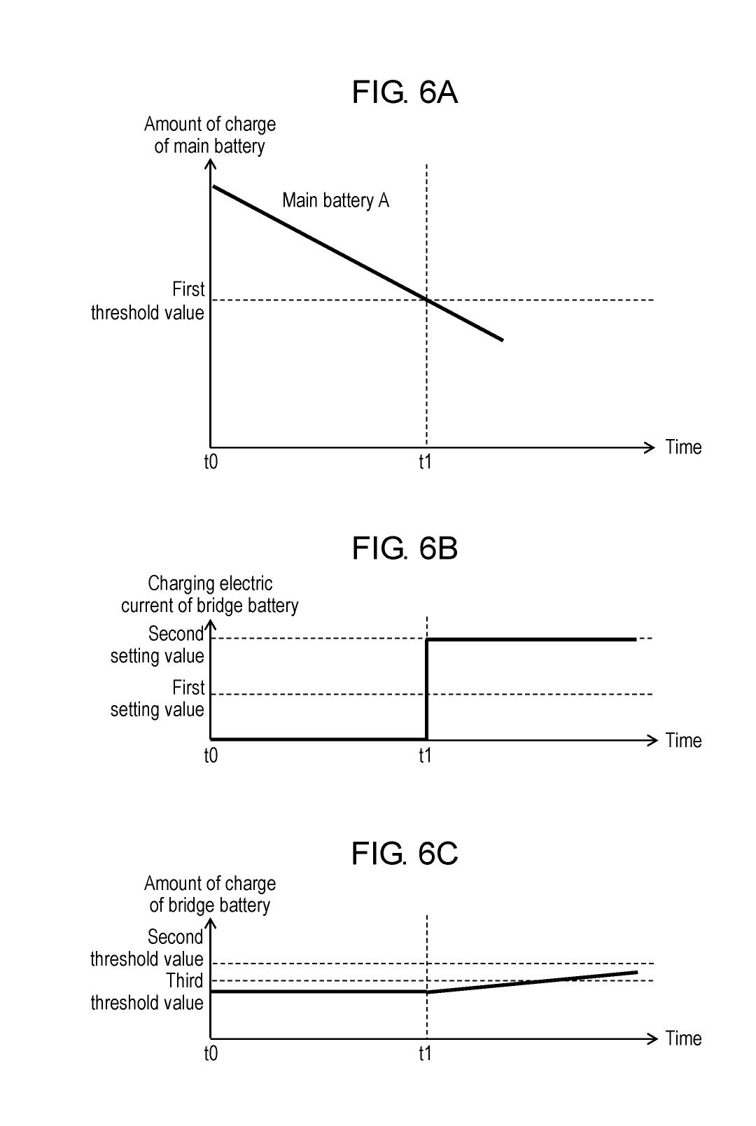

FIG. 6 is a view for illustrating an example of an operation for setting a setting value of a charging electric current for bridge battery 13 during hot swapping of main battery 11 in the second exemplary embodiment. FIG. 6A illustrates a charging state of main battery 11. FIG. 6B illustrates setting of the setting value of the charging electric current for bridge battery 13. FIG. 6C illustrates a change of a charging state of bridge battery 13.

FIG. 6A illustrates a case where an amount of charge (remaining battery level) of main battery 11 decreases with passage of time and becomes lower than the first threshold value at time t1. In this case, an amount of charge of bridge battery 13 is lower than the second threshold value and the third threshold value. Accordingly, power controller 19 sets the setting value of the charging electric current for bridge battery 13 to the second setting value as illustrated in FIG. 6B, and thus rapidly charges bridge battery 13 as illustrated in FIG. 6C.

As described above, according to information processing device 100 of the present exemplary embodiment, power controller 19 sets the setting value of the charging electric current for bridge battery 13 (an example of a sub-battery) to the first setting value (S24) in a case where the amount of charge of main battery 11 is smaller than the first threshold value (an example of a threshold value concerning an amount of charge of a main battery) (YES in S20) and where the amount of charge of bridge battery 13 is equal to or larger than the third threshold value (an example of a threshold value concerning an amount of charge of a sub-battery) (YES in S23), whereas power controller 19 sets the setting value of the charging electric current for bridge battery 13 to the second setting value that is larger than the first setting value (S26) in a case where the amount of charge of bridge battery 13 is smaller than the third threshold value (NO in S23).

Such control makes it possible to speedily set bridge battery 13 to a fully charged state in a case where an amount of charge of main battery 11 becomes small. This makes it possible to speedily create an environment for replacing main battery 11 as soon as a user recognizes that an amount of charge of main battery 11 is small.

### Other Exemplary Embodiments

Hereinabove, the first exemplary embodiment has been described as illustration of the technique disclosed in the present application. However, the technique of the present disclosure is not limited to the first exemplary embodiment, but is applicable to another exemplary embodiment in which a change, a replacement, an addition, or an omission is appropriately made. A new exemplary embodiment can also be made by a combination of the components of the first exemplary embodiment. Accordingly, other exemplary embodiments will be described below.

In the first exemplary embodiment, power controller 19 is a programmable microcontroller. However, power controller 19 may be another device. For example, power controller 19 may be realized only by a hardware circuit specially designed so that a predetermined function is realized. Specifically, power controller 19 may be, a central processing unit (CPU), an micro processing unit (MPU), a digital signal processor (DSP), a field programmable gate array (FPGA), an application specific integrated circuit (ASIC), or the like.

In the first exemplary embodiment, an information processing device (notebook computer) has been described as an example of an electronic device. However, the idea of the present disclosure is applicable to various electronic devices (a tablet terminal, a word processor, and an electronic dictionary) having a battery that is replaceable while power of the device is on.

The operation for setting a charging electric current for bridge battery 13 described in the first exemplary embodiment and the operation for setting a charging electric current for bridge battery 13 described in the second exemplary embodiment may be combined. Bridge battery 13 may be charged when an amount of charge of bridge battery 13 becomes equal to or smaller than a predetermined value irrespective of an amount of charge of main battery 11.

The exemplary embodiments have been described above and exemplified as the technique of the present disclosure. The accompanying drawings and detailed description have been provided for this purpose.

Accordingly, the components described in the appended drawings and the detailed description include, in order to exemplify the above described technique, not only essential components for solving the problem but also components that are not essential for solving the problem. Therefore, it should not be immediately construed that these components that are not essential are essential even if the components are described in the accompanying drawings and the detailed description.

Since the above described exemplary embodiments are for exemplifying the technique of the present disclosure, various modifications, replacements, additions, and omissions can be made within the scope of the appended claims or of their equivalents.

The present disclosure is useful for an electronic device, such as a notebook computer or a word processor, having a battery that is replaceable while power of the device is on.

What is claimed is:

1. An electronic device including a load circuit, comprising:
a main battery that supplies electric power to the load circuit;
a sub-battery that supplies electric power to the load circuit in a case where the main battery is detached from the electronic device;
a first charging circuit that charges the main battery;
a second charging circuit that charges the sub-battery; and
a controller that controls the first and second charging circuits,
wherein the controller changes a setting value of a charging electric current of the second charging circuit for the sub-battery based on an amount of charge of the main battery.

2. The electronic device according to claim 1, wherein
upon detection of replacement of the main battery,
the controller sets the setting value of the charging electric current for the sub-battery to a first setting value in a case where the amount of charge of the main battery is equal to or larger than a predetermined threshold value, and
the controller sets the setting value of the charging electric current for the sub-battery to a second setting value that is larger than the first setting value in a case where the amount of charge of the main battery is smaller than the predetermined threshold value.

3. The electronic device according to claim 1, wherein
when the amount of charge of the main battery becomes smaller than a threshold value concerning the amount of charge of the main battery,
the controller sets the setting value of the charging electric current for the sub-battery to a first setting value in a case where an amount of charge of the sub-battery is equal to or larger than a threshold value concerning the amount of charge of the sub-battery, and
the controller sets the setting value of the charging electric current for the sub-battery to a second setting value that is larger than the first setting value in a case where the amount of charge of the sub-battery is smaller than the threshold value concerning the amount of charge of the sub-battery.

4. The electronic device according to claim 1, wherein
electric power is supplied from the sub-battery to the load circuit in a case where the main battery is detached from the electronic device while power of the electronic device is on.

5. The electronic device according to claim 1, wherein
the sub-battery has a smaller capacity than the main battery and is fixed in the electronic device.
